(19) United States
(12) Patent Application Publication
(10) Pub. No.: US 2007/0123425 A1
(43) Pub. Date: May 31, 2007

(54) AQUEOUS SUSPENSION CONCENTRATES

(75) Inventors: Gerhard Frisch, Wehrheim (DE); Roland Deckwer, Frankfurt (DE); Janine Rude, Kriftel (DE); Ulrike Ebersold, Hattersheim (DE)

Correspondence Address: FROMMER LAWRENCE & HAUG, 745 FIFTH AVENUE- 10TH FL., NEW YORK, NY, 10151, US

(73) Assignee: Bayer CropScience GmbH, Frankfurt (DE)

(21) Appl. No.: 11/562,539

(22) Filed: Nov. 22, 2006

(30) Foreign Application Priority Data
Nov. 25, 2005 (EP) 05025748.4

(51) Int. Cl. A01N 43/82; A01N 25/02

(52) U.S. Cl. 504/265; 504/362

(57) ABSTRACT

The invention relates to aqueous suspension concentrates which comprise: (1) one or more active substances from the group consisting of the oxadiazoles, (2) one or more surfactants based on non-salt-like substituted phenol ethers, (3) one or more thickeners based on aluminum silicate, and (4) optionally additional formulation auxiliaries, and also (5) optionally additional surfactants other than component (2). This makes possible, in addition to avoiding crystal growth, inter alia also highly concentrated aqueous herbicidal compositions with good distribution of active substance.

This application claims benefit under 35 U.S.C. 119(a) of European patent application 05025747.6, filed on 25 Nov. 2005.

Any foregoing applications, including European patent application EP 05025747.6, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The invention relates to the technical field of the formulations of active substances.

Active substances can in principle be formulated in many different ways, it being possible for the properties of the active substances and type of the formulation to raise problems with regard to the ease of preparation, stability, applicability and effectiveness of the formulations. In addition, some formulations are more advantageous than others for economic and ecological reasons.

Water-based formulations generally have the advantage that they require a reduced amount of organic solvents or none at all.

On the other hand, there generally exists a requirement for highly concentrated formulations of active substances as there are many different advantages to the higher concentration; for example, a lower consumption of packaging material is necessary with highly concentrated formulations than with formulations of low concentration. The expenditure on preparation, transportation and storage is correspondingly reduced; in addition, e.g., it is simpler to prepare the spray slurries used in agriculture due to the smaller amounts of plant protection products, for example, which have to be handled, such as, e.g., in the filling and mixing operation.

More highly concentrated aqueous suspension concentrates are known, such as, e.g., of sulfur (EP-A-0 220 655) and metamitron (EP-A-0 620 971), which have as basis mixtures of formaldehyde condensation products, preferably lignosulfonates and wetting agents.

The active substances from the group of the oxadiazoles are highly effective herbicides with an effect against harmful plants in crop plants. Admittedly this group of active substances reacts problematically in the formulation type of the more highly concentrated aqueous suspension concentrate with regard to the solution behavior. In standard suspension concentrates, a critical limit, beyond which critical growth can be expected, is very quickly exceeded, which then results in an unstable formulation by sedimentation of the crystals grown. In addition, the crystals in the formulation formed by growth can result in blocking of the filters and of the nozzles during the application, with the serious consequence of a nonuniform application or even the complete prevention of the application, resulting in a partial to complete loss in effectiveness.

It was accordingly the object of the present invention to make available a formulation of the type of a more highly concentrated aqueous suspension concentrate which overcomes the disadvantages listed, in particular the formation of the crystal growth, with the aim of a better distribution as basis for an optimum application and effect.

It has been found, surprisingly, that this object is achieved by the aqueous suspension concentrates of the present invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

A subject matter of the invention is an aqueous suspension concentrate which comprises:
(1) one or more active substances from the group consisting of the oxadiazoles,
(2) one or more surfactants based on non-salt-like substituted phenol ethers,
(3) one or more thickeners based on aluminum silicate.

In addition, the aqueous suspension concentrate according to the invention can also optionally comprise, as additional components:
(4) additional formulation auxiliaries, and
(5) additional surfactants other than component (2).

The term “aqueous suspension concentrates” is to be understood as meaning suspension concentrates based on water. The proportion of water in the suspension concentrates according to the invention can generally be 25-98% by weight, preferably 35-85% by weight; in this connection, the specification “% by weight”, here and throughout the description, unless otherwise specified, refers to the relative weight of the respective component, based on the total weight of the formulation.

The active substances (component 1) are active substances from the group consisting of the oxadiazoles. The “Pesticide Manual” (PM), 13th edition, The British Crop Protection Council (2003), mentions, as representatives from the group consisting of the oxadiazoles, for example: 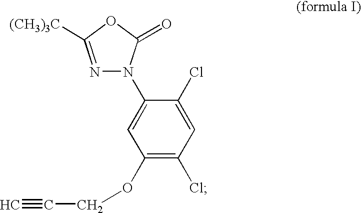
oxadiargyl (PM, pp. 725-726, formula I) chemical name: 5-tert-butyl-3-[2,4-dichloro-5-(prop-2-ynyloxy)phenyl]-1,3,4-oxadiazol-2(3H)-one 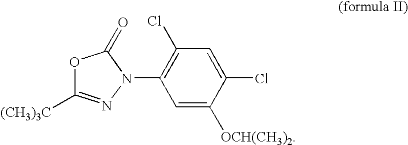
oxadiazon (PM, pp. 727-728, formula II) chemical name: 5-tert-butyl-3-(2,4-dichloro-5-isopropoxyphenyl)-1,3,4-oxadiazol-2(3H)-one

Other examples of oxadiazoles include but are not limited to dimefuron.

Preferably, oxadiargyl and oxadiazon are suitable as active substances from the group consisting of the oxadiazoles.

The proportion of active substances (component 1) in the suspension concentrates according to the invention is 5-60% by weight, preferably 10-50% by weight, particularly preferably 15-48% by weight.

In a particular embodiment of the invention, the active substances (component 1) are present with a minimum content of 300 g of active substance/l, preferably 350-820 g of active substance/l, of the combined formulation.

The surfactants (component 2) based on non-salt-like substituted phenol ethers are, for example, nonionic mono-, di- and, preferably, trisubstituted phenols which can be alkoxylated, e.g. ethoxylated and/or propoxylated and/or butoxylated. In this connection, the number of the alkyleneoxy units can lie in the range between 1 and 100, preferably 3 and 60, particularly preferably 5 and 25. Substituents on the phenol ring of the phenol derivatives are preferably styryl or isoalkyl radicals. In this connection, the term “styryl radical” describes the radical which is produced by aromatic substitution of the phenol by styrene, i.e. a “1-phenylethyl radical”. Examples are phenyl (C₁-C₄)alkyl ethers or (poly)alkoxylated phenols [=phenol (poly)alkylene glycol ethers], for example with 1 to 50 alkyleneoxy units in the (poly)alkyleneoxy part, the alkylene part preferably exhibiting 2 to 4 carbon atoms each time, preferably phenol reacted with 3 to 10 mol of alkylene oxide, (poly)alkylphenols or (poly)alkylphenol alkoxylates [=polyalkylphenol (poly)alkylene glycol ethers], for example with 1 to 12 carbon atoms per alkyl radical and 1 to 150 alkyleneoxy units in the polyalkyleneoxy part, preferably tri(n-butyl)phenol or triisobutylphenol reacted with 1 to 50 mol of ethylene oxide, polyarylphenols or polyarylphenol alkoxylates [=polyarylphenol (poly)alkylene glycol ethers], for example tristyrylphenol polyalkylene glycol ethers with 1 to 150 alkyleneoxy units in the polyalkyleneoxy part, preferably tristyrylphenol reacted with 1 to 50 mol of ethylene oxide (=tristyrylphenol with 1 to 50 EO=ethyleneoxy units).

The nonionic surfactants mentioned can also be modified with functional groups, for example be phosphated or sulfated. However, as component (2), they must then be used in their acid form and not in the neutralized salt form. Phosphated or sulfated nonionic surfactants in which the phosphoric acid or sulfate groups are completely esterified are likewise possible.

Preference is given to tri[(C₁-C₄)alkyl]phenol alkoxylates with 1 to 30 EO or tristyrylphenol alkoxylates with 10 to 30 EO. Correspondingly phosphated surfactants in the non-salt-like (acid) form are likewise preferably suitable.

Examples of surfactants of the component (2) are Soprophor® 3D33 (=tristyrylphenol, ethoxylated with 16 EO and phosphated), Soprophor® BSU (=tristyrylphenol, ethoxylated with 16 EO), Soprophor® CY/8 (Rhodia) (=tristyrylphenol, ethoxylated with 20 EO) and Hoe® S3474 (=tristyrylphenol, ethoxylated with 20 EO), and in the form of the Sapogenat® T products (Clariant), for example Sapogenat® T 100 (=tri-isobutylphenol, ethoxylated with 10 EO).

Examples of nonionic surfactants are also phenol reacted with 4 to 10 mol of ethylene oxide, available commercially, for example, in the form of the Agrisol® products (Akcros), and nonylphenol reacted with 4 to 50 mol of ethylene oxide, available commercially, for example, in the form of the Arkopal® products (Clariant).

Examples of non-salt-like surfactants are the acidic phosphoric esters of tristyrylphenol reacted with 1 to 50 mol of ethylene oxide, such as Soprophor® 3D33 or Soprophor® 4D-384 (Rhodia), or acidic (linear) dodecylbenzenesulfonic acid, available commercially, for example in the form of the Marlon® products (Hüls).

Mixtures of several surfactants from the group consisting of the non-salt-like surfactants are also preferred for the component (2).

Preference is given in this connection to mixtures of one or more of the abovementioned nonionic surfactants; mixtures of one or more of the abovementioned nonionic surfactants and one or more of the abovementioned non-salt-like (acidic) phosphated surfactants are also preferred.

The proportion of surfactants in the suspension concentrates according to the invention is generally 0.1-20% by weight, preferably 0.5-10% by weight, particularly preferably 1-7% by weight.

Possible thickeners (component 3) based on aluminum silicate are, for example, those such as hectorites, montmorillonites, saponites, kaolinites, bentonites, attapulgites and the like.

Examples of such thickeners are the Attagels® from Engelhardt Corp, e.g. Attagel 50, a hydrous magnesium aluminum silicate (attapulgite) or the Bentone® series from Elementis, such as Bentone EW, a hydrous magnesium aluminum silicate (bentonite).

The proportion of thickeners based on aluminum silicate in the suspension concentrates according to the invention is 0.01-5% by weight, preferably 0.1-3.5% by weight.

The thickeners according to component (3) can also be used mixed with thickeners of other types, for example with organic thickeners, such as agar, carrageenan, gum tragacanth, gum arabic, alginates, pectins, polysaccharides, guar flour, locust bean flour, starch, dextrins, cellulose ethers, such as carboxymethylcellulose and hydroxyethylcellulose, polyacrylic and polymethacrylic compounds, vinyl polymers, polyethers or polyamides.

Examples of preferred thickeners which can be used in combination with component (3) are xanthans (heteropolysaccharides), such as the Rhodopol® products from Rhodia, e.g. Rhodopol 23 (a xanthan).

In addition, yet further formulation auxiliaries, such as antifoaming agents, antifreeze agents, preservatives, dyes or fertilizers, and also surfactants other than component (2), can be added to these formulations. These formulation auxiliaries are described for example in Chemistry and Technology of Agrochemical Formulations, ed. D. A. Knowles, Kluwer Academic Publishers (1998) and Controlled-Release Delivery Systems for Pesticides, Herbert B. Scher, Marcel Dekker, Inc. (1999).

The proportion of these formulation auxiliaries in the suspension concentrates according to the invention is preferably 0.1-22% by weight, in particular 0.5-18% by weight, more preferably 1-15% by weight.

Possible antifoaming agents are standard foam-inhibiting compounds, such as silicone-based antifoaming agents, for example from Wacker, Rhodia or Dow Corning, and acetylene-based antifoaming agents, such as, for example, those from Air Products. A suitable antifoaming agent is, for example, Rhodosil® 481 (polydimethylsiloxane and silicon) from Rhodia.

Possible antifreeze agents are, for example, glycol, propylene glycol, glycerol and urea.

Possible preservatives are standard biocidal compounds, for example Acticide® MBS (mixture of 1,2-benzoisothiazol-3(2H)-one and 2-methyl-2H-isothiazol-3-one, biocide) from Thor.

Examples of additional surfactants other than component (2) are listed below, in which EO=ethylene oxide units, PO=propylene oxide units and BO=butylenes oxide units:
1) C₁₀-C₂₄-Alcohols, which can be alkoxylated, e.g., with 1-60 alkylene oxide units, preferably 1-60 EO and/or 1-30 PO and/or 1-15 BO, in any sequence. The terminal hydroxyl groups of these compounds can be end group closed by an alkyl, cycloalkyl or acyl radical with 1-24 carbon atoms. Examples of such compounds are:
Genapol® C, L, O, T, UD, UDD, X products from Clariant, Plurafac® and Lutensol® A, AT, ON, TO products from BASF, Marlipal® 24 and O13 products from Condea, Dehypon® products from Henkel, Ethylan® products from Akzo-Nobel, such as Ethylan CD 120.
2) Anionic derivatives of the products described under 1) in the form of ether carboxylates, sulfonates, sulfates and phosphates and the inorganic (e.g., alkali metal and alkaline earth metal) and organic (e.g., amine- or alkanolamine-based) salts thereof, such as Genapol® LRO, Sandopan® products, Hostaphat/Hordaphos® products from Clariant.
Copolymers consisting of EO, PO and/or BO units, such as, for example, block copolymers, such as the Pluronic® products from BASF and the Synperonic® products from Uniquema, with a molecular weight of 400 to 10⁸. Alkylene oxide adducts of C₁-C₉-alcohols, such as Atlox® 5000 from Uniquema or Hoe® S3510 from Clariant.
3) Fatty acid and triglyceride alkoxylates, such as the Serdox® NOG products from Condea or alkoxylated vegetable oils, such as soybean oil, rapeseed oil, corn oil, sunflower oil, cottonseed oil, linseed oil, coconut oil, palm oil, thistle oil, walnut oil, peanut oil, olive oil or castor oil, in particular rapeseed oil, the term “vegetable oils” also being understood as meaning the transesterification products thereof, e.g. alkyl esters, such as rapeseed oil methyl ester or rapeseed oil ethyl ester, for example the Emulsogen® products from Clariant, salts of aliphatic, cycloaliphatic and olefinic carboxylic acids and polycarboxylic acids, and (α-sulfofatty acid esters, as available from Henkel.
4) Fatty acid amide alkoxylates, such as the Comperlan® products from Henkel or the Amam® products from Rhodia.
Alkyleneoxy adducts of alkynediols, such as the Surfynol® products from Air Products. Sugar derivatives, such as amino- and amidosugars from Clariant, glucitols from Clariant, alkylpolyglycosides in the form of the APG® products from Henkel or such as sorbitan esters in the form of the Span® or Tween® products from Uniquema or cyclodextrin esters or ethers from Wacker.
5) Surface-active cellulose and algin, pectin and guar derivatives, such as the Tylose® products from Clariant, the Manutex® products from Kelco and guar derivatives from Cesalpina.
Alkylene oxide adducts based on polyols, such as the Polyglykol® products from Clariant. Surface-active polyglycerides and the derivatives thereof from Clariant.
6) Sulfosuccinates, alkanesulfonates, paraffinsulfonates and olefinsulfonates, such as Netzer IS®, Hoe® S1728, Hostapur® OS, Hostapur® SAS from Clariant, Triton® GR7ME and GR5 from Union Carbide, Empimin® products from Albright and Wilson, Marlon® PS65 from Condea.
7) Sulfosuccinamates, such as the Aerosol® products from Cytec or the Empimin® products from Albright and Wilson.
8) Alkylene oxide adducts of fatty amines, quaternary ammonium compounds with 8 to 22 carbon atoms (C₈-C₂₂), such as, e.g., the Genamin® C, L, O, T products from Clariant.
9) Surface-active zwitterionic compounds, such as taurides, betaines and sulfobetaines in the form of Tegotain® products from Goldschmidt, Hostapon® T and Arkopon® T products from Clariant.
10) Surface-active compounds based on silicones or silanes, such as the Tegopren® products from Goldschmidt and the SE® products from Wacker, and also the Bevaloid®, Rhodorsil® and Silcolapse® products from Rhodia (Dow Corning, Reliance, GE, Bayer).
11) Per- or polyfluorinated surface-active compounds, such as the Fluowet® products from Clariant, the Bayowet® products from Bayer, the Zonyl® products from DuPont and products of this type from Daikin and Asahi Glass.
12) Surface-active sulfonamides, e.g. from Bayer.
13) Surface-active polyacrylic and polymethacrylic derivatives, such as the Sokalan® products from BASF.
14) Surface-active polyamides, such as modified gelatin or derivatized polyaspartic acid from Bayer and the derivatives thereof.
15) Surface-active polyvinyl compounds, such as modified polyvinylpyrrolidone, such as the Luviskol® products from BASF and the Agrimer® products from ISP, or derivatized poly(vinyl acetate)s, such as the Mowilith® products from Clariant, or poly(vinyl butyrate)s, such as the Lutonal® products from BASF, the Vinnapas® and the Pioloform® products from Wacker, or modified poly(vinyl alcohol)s, such as the Mowiol® products from Clariant.
16) Surface-active polymers based on maleic anhydride and/or reaction products of maleic anhydride, and also copolymers comprising maleic anhydride and/or reaction products of maleic anhydride, such as the Agrimer® VEMA products from ISP.
17) Surface-active derivatives of montan, polyethylene and polypropylene waxes, such as the Hoechst® waxes or the Licowet® products from Clariant.
18) Surface-active phosphonates and phosphinates, such as Fluowet® PL from Clariant.
19) Poly- or perhalogenated surfactants, such as, for example, Emulsogen® 1557 from Clariant.
20) Anionic compounds which are formally the reaction products of the abovementioned phenols of the component (2) with sulfuric acid or phosphoric acid and are neutralized with suitable bases (salts), for example the acidic phosphoric ester, neutralized with NaOH, of triethoxylated phenol, the acidic phosphoric ester, neutralized with NaOH, of a nonylphenol reacted with 9 mol of ethylene oxide and the phosphoric ester, neutralized with triethanolamine, of the reaction product of 20 mol of ethylene oxide and 1 mol of tristyrylphenol.
21) Benzenesulfonates, such as alkyl- or arylbenzenesulfonates, e.g. (poly)alkyl- and (poly)arylbenzenesulfonates neutralized with suitable bases, for example having 1 to 12 carbon atoms per alkyl radical or having up to 3 styrene units in the polyaryl radical, preferably (linear) dodecylbenzenesulfonic acid and preferably the sodium salts thereof or the oil-soluble salts thereof, such as, for example, the calcium salt or the isopropylammonium salt of dodecylbenzenesulfonic acid. 1,2-Ethyleneoxy, 1,2-propyleneoxy, 1,2-butyleneoxy and 2,3-butyleneoxy units, in particular 1,2-ethyleneoxy units, are preferred for the alkyleneoxy units.

Examples of surfactants from the group consisting of nonaromatic-based surfactants are surfactants of the abovementioned groups 1) to 19), preferably of the groups 1), 2), 6) and 8).

Examples of surfactants from the group consisting of aromatic-based surfactants are surfactants of the abovementioned groups 20) and 21), preferably the neutralized phosphoric ester of tristyrylphenol reacted with 1 to 50 mol of ethylene oxide, from the Soprophor® series (Rhodia), such as Soprophor® FL.

The suspension concentrates according to the invention can be prepared in a known way (see Winnacker-Küchler, “Chemische Technologie [Chemical Technology]”, Volume 7, C. Hanser Verlag, Munich, 4th edition, 1986), e.g. by wet milling the components, which can take place in suitable mills, e.g. in bead mills (such as, e.g., bead mills operating batchwise, e.g. from Drais, or bead mills operating continuously, e.g. from Bachofen) or colloid mills (such as, e.g., toothed colloid mills, e.g. from Probst+Claasen).

In a preferred embodiment of the invention, milling is carried out until 50% of the particles of the formulation exhibit a size of less than or equal to 4 μm (d50≦4 μm).

Preferably, in this connection, the active substances (component 1) in the formulation exhibit a particle size of d50 less than or equal to 4 μm; in particular, 60% or very particularly 80% of the active substance particles exhibit a particle size ranging from 1 to 4 μm.

In a very particularly preferred embodiment of the invention, the active substances (component 1) in the suspension concentrate according to the invention exhibit a minimum content of 350 g of active substance/l, preferably 440-820 g of active substance/l, of the combined formulation and, additionally, up to 50% of the particles of the combined formulation, preferably 50% of the particles of the active substances (component 1), exhibit a size, after the milling, of less than or equal to 4 μm (d50≦4 μm); in particular, 60%, very particularly 80%, of the respective particles exhibit a size of 1 to 4 μm.

The invention furthermore relates to compositions which can be obtained from the suspension concentrate according to the invention by diluting with liquids, preferably water.

It can be advantageous to treat the compositions thus obtained with additional active substances, preferably agrochemical active substances (e.g., as tank mix partners in the form of appropriate formulations) and/or auxiliaries and additives standard in the application, e.g. self-emulsifying oils, such as vegetable oils or paraffin oils, and/or fertilizers. The present invention also accordingly relates to those compositions, preferably herbicidal compositions, based on the suspension concentrates according to the invention.

In this connection, the term “agrochemical active substances” embraces all substances which are used in the agricultural, horticultural, forestry and animal husbandry fields, and also in the domestic sphere and in stockpiling. These agrochemical active substances include, for example, herbicides, insecticides, acaricides, rodenticides, fungicides, bactericides, nematicides, algicides, molluscicides, viricides, safeners, active substances which induce resistance to plant damage, active substances effective as repellents and active substances effective as growth regulators, active substances with and from biological organisms, and fertilizers. Particular preference is given to active substances effective as herbicides, insecticides, acaricides, fungicides, bactericides, viricides and growth regulators or as safeners. Very particular preference is given to herbicides, insecticides, fungicides and safeners and, in turn, among them, herbicidal active substances are preferred.

A particular embodiment of the invention relates to the use of the compositions obtainable from the suspension concentrates according to the invention for combating undesirable plant growth, described subsequently as “herbicidal compositions”.

The herbicidal compositions exhibit an outstanding herbicidal activity against a broad spectrum of economically important harmful monocotyledonous and dicotyledonous plants. Even perennial weeds which sprout from rhizomes, root stocks or other perennial organs and which are difficult to combat are successfully included. In this connection, the herbicidal compositions can be applied, e.g., in the presowing, preemergence or postemergence method. Specifically, mention may be made, by way of example, of some representatives of the mono- and dicotyledonous weed flora which can be controlled by the herbicidal compositions, without the designation resulting in a limitation to certain species.

In the case of the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp., such as Bromus catharticus, Bromus secalinus, Bromus erectus, Bromus tectorum and Bromus japonicus, and Cyperus species from the group of the annuals and, in the case of the perennial species, Agropyron, Cynodon, Imperata and also Sorghum and even perennial Cyperus species, e.g., are successfully included.

With dicotyledonous weed species, the spectrum of activity applies to species such as, e.g., Abutilon spp., Amaranthus spp., Chenopodium spp., Chrysanthemum spp., Galium spp., such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., in the case of the annuals, and Convolvulus, Cirsium, Rumex and Artemisia with the perennial weeds.

Harmful plants occurring under the specific cultivation conditions in rice, such as, e.g., Echinochloa, Sagittaria, Alisma, Eleocharis, Scirpus and Cyperus, are likewise combated in an outstanding fashion by the herbicidal compositions.

If the herbicidal compositions are applied to the soil surface before germination, then either the emergence of the weed seedlings is completely prevented or the weeds grow until they have reached the cotyledon stage but then their growth ceases and finally, after 3 to 4 weeks have elapsed, they completely die.

On application of the herbicidal compositions to the green parts of the plants in the postemergence method, a drastic halt in growth likewise occurs very quickly after the treatment and the weed plants stay in the growth stage present at the time of application or completely die after a certain time, so that in this way competition by weeds, which is harmful for the crop plants, is eliminated very early and with lasting effect.

The herbicidal compositions are distinguished by a rapidly commencing and longlasting herbicidal action. The resistance to rain of the active substances in the herbicidal compositions is generally good. A particular advantage is crucially that the dosages of herbicidal compounds which are used in the herbicidal compositions and which are effective can be adjusted to such a low value that their soil action is optimally low. Accordingly, not only is their use finally possible in sensitive crops but groundwater contamination is virtually avoided. A substantial reduction in the amount of the active substances which has to be expended is made possible by the active substance combination according to the invention.

The properties and advantages mentioned are of use in the practical combating of weeds in order to keep agricultural crops free from undesirable competing plants and accordingly to safeguard and/or to increase the yields in terms of quality and quantity.

The technical standard is, with regard to the properties described, clearly exceeded by these new herbicidal compositions.

Although the herbicidal compositions exhibit an outstanding herbicidal activity with regard to mono- and dicotyledonous weeds, crop plants of economically important crops, e.g. dicotyledonous crops, such as soya, cotton, rape, sugar beet, or gramineous crops, such as wheat, barley, rye, oats, millet, rice or corn, or preferably plantation crops, are only insignificantly damaged or completely undamaged. The present herbicidal compositions, for these reasons, are very well suited to the selective combating of undesirable plant growth in agriculturally useful plants or in ornamental plants.

In addition, the corresponding herbicidal compositions exhibit outstanding growth-regulatory properties in crop plants. They intervene in a regulatory manner in the plants' metabolism and can accordingly be used for the selective influencing of plant contents and for making it easier to harvest, such as, e.g., by controlling desiccation and stunted growth. Furthermore, they are also suitable for the general control and inhibition of undesirable vegetative growth, without in this connection killing the plants. Inhibition of vegetative growth plays a major role in many mono- and dicotyledonous crops since lodging can be reduced or completely prevented through this.

Because of their herbicidal and plant-growth-regulatory properties, the herbicidal compositions can also be used for combating harmful plants in crops of known genetically modified plants or genetically modified plants still to be developed. The transgenic plants are generally distinguished by particular advantageous properties, for example by resistance to certain pesticides, mainly certain herbicides, resistance to plant diseases or causative agents of plant diseases, such as certain insects or microorganisms, such as fungi, bacteria or viruses. Other particular properties relate, e.g., to the harvested crops with regard to amount, quality, storability, composition and special ingredients. Thus, transgenic plants with increased starch content or modified quality of the starch or those with a different fatty acid composition of the harvested crops are known.

Preference is given to the use of the herbicidal compositions in economically important transgenic crops of useful and ornamental plants, e.g. of gramineous crops, such as wheat, barley, rye, oats, millet, rice and corn, or also crops of sugar beet, cotton, soya, rape, potato, tomato, peas and other kinds of vegetable. Preferably, the herbicidal compositions can be used in crops of useful plants which are resistant to the phytotoxic effects of the herbicides or which have been made resistant by genetic engineering.

When the herbicidal compositions are used in transgenic crops, effects often occur, in addition to the effects with regard to harmful plants to be observed in other crops, which are specific for the application in the respective transgenic crop, for example a modified or specially broadened weed spectrum which can be combated, modified amounts to be expended which can be used for the application, preferably good ability to be combined with the additional herbicidal active substances to which the transgenic crop is resistant, and influencing of growth and yield of the transgenic crop plants.

Another subject matter of the present invention is accordingly a process for combating undesirable plant growth, preferably in crop plants, such as cereals (e.g., wheat, barley, rye, oats, rice, corn, millet), sugar beet, sugar cane, rape, cotton and soya, particularly preferably in monocotyledonous crops, such as cereals, e.g. wheat, barley, rye, oats, hybrids thereof, such as triticale, rice, corn and millet, wherein the herbicidal compositions according to the invention are applied to the harmful plants, plant parts, plant seeds or the area on which the plants are growing, e.g. the area under cultivation.

Another subject matter of the invention is a process for combating undesirable plant growth in plantation crops, wherein the herbicidal compositions according to the invention are applied to the harmful plants, plant parts, plant seeds or the area on which the plants are growing, e.g. the area under cultivation.

The crop plants can also be modified by genetic engineering or obtained by mutation selection and are preferably tolerant to acetolactate synthase (ALS) inhibitors (see, e.g., EP-A-0 257 993, U.S. Pat. No. 5,013,659) or glyphosate herbicides (see WO 92/00377, U.S. Pat. No. 5,463,175) or glufosinate herbicides (see EP-A-0 242 236, EP-A-242 246, U.S. Pat. No. 5,432,971).

With the suspension concentrates according to the invention, a better biological action is generally achieved for the same amount consumed.

In addition, the highly concentrated formulation of active substances in the suspension concentrates according to the invention makes possible the advantages associated therewith, such as, e.g., a lower consumption of packaging material, through which the cost of preparation, transportation and storage is reduced and the formulating of the spray slurries used in agriculture can be better handled through the smaller amounts, such as, e.g., in the filling and mixing operation.

The suspension concentrates according to the invention additionally display, surprisingly, excellent dispersing and stabilizing properties after further diluting with liquids, preferably water.

In addition, the suspension concentrates according to the invention produce formulations which are stable on storage (over a long time) and which perform perfectly.

The invention is further described by the following non-limiting examples which further illustrate the invention, and are not intended to, nor should they be interpreted to, limit the scope of the invention.

### EXAMPLES

1. Preparation:

Water is placed in a vessel and circulated by pumping through a colloid mill. Thickeners (e.g., Attagel®; Bentone®; Rhodopol®) and optionally formulation auxiliaries, such as, for example, preservatives (e.g., Acticide®), are added, followed by the surfactants (e.g., Soprophor®). The active substance is added as final component. The combined mixture is then transferred via the colloid mill into an additional vessel. This mixture is then milled by wet milling using bead mills.

2. Compositions:

TABLE I
Formulation examples Nos. 1-10

| | Example No.: | | | | | | | | | |
|---|---|---|---|---|---|---|---|---|---|---|
| | 1 | 2 | 3 | 4 | 5 | 6 | 7 | 8 | 9 | 10 |
| Oxadiargyl | 40 | 44 | 45 | 46 | 48 | 50 | — | — | — | — |
| Oxadiazon | — | — | — | — | — | — | 36 | 40 | 45 | 46 |
| Attagel ® 50 | — | — | — | — | — | 0.4 | — | 0.5 | 0.35 | 0.3 |
| Bentone ® SD 1 | — | — | — | — | 0.3 | — | — | — | — | — |
| Bentone ® EW | 0.1 | 0.15 | 0.1 | 0.15 | — | 0.3 | 0.15 | — | — | 0.2 |
| Rhodopol ® 23 | 0.2 | 0.08 | 0.1 | 0.1 | — | — | 0.2 | 0.1 | 0.07 | — |
| Acticide ® MBS | 0.1 | 0.1 | 0.1 | 0.1 | — | — | 0.1 | 0.1 | 0.1 | — |
| Soprophor ® BSU | 2.2 | 1.9 | 2.1 | 2.0 | 4.0 | 3.8 | 2.1 | 1.8 | 2.6 | 4.1 |
| Soprophor ® 3D33 | 1 | 1.5 | 1.2 | 1.4 | — | — | 1.0 | 1.2 | 1.3 | — |
| Soprophor ® CY/8 | 0.4 | 0.7 | 0.5 | 0.6 | 0.8 | 0.7 | 0.45 | 0.5 | 0.9 | 0.6 |
| Water | to | to | to | to | to | to | to | to | to | to |
| | 100 | 100 | 100 | 100 | 100 | 100 | 100 | 100 | 100 | 100 |

All specifications in % by weight

The suspension concentrates according to the invention listed in table I exhibit the desired properties.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. An aqueous suspension concentrate which comprises:
(1) one or more active substances from the group consisting of the oxadiazoles,
(2) one or more surfactants based on non-salt-like substituted phenol ethers,
(3) one or more thickeners based on aluminum silicate.

2. A suspension concentrate as claimed in claim 1, which furthermore comprises additional formulation auxiliaries (component 4).

3. A suspension concentrate as claimed in claim 1, which furthermore comprises additional surfactants other than component (2) (component 5).

4. A suspension concentrate as claimed in claim 1, which comprises oxadiargyl as active substance (component 1).

5. A suspension concentrate as claimed in claim 1, which comprises oxadiazon as active substance (component 1).

6. A suspension concentrate as claimed in claim 1, which comprises the active substances (component 1) with a minimum content of 300 g of active substance/l of the combined formulation.

7. A suspension concentrate as claimed in claim 1, wherein 50% of the particles of the formulation exhibit a size of less than or equal to 4 μm.

8. A suspension concentrate as claimed in claim 6, wherein the active substance (component 1) is oxadiargyl.

9. A suspension concentrate as claimed in claim 7, wherein the active substance (component 1) is oxadiargyl.

10. A suspension concentrate as claimed in claim 6, wherein the active substance (component 1) is oxadiazon.

11. A suspension concentrate as claimed in claim 7, wherein the active substance (component 1) is oxadiazon.

12. A suspension concentrate as claimed in claim 6 wherein 50% of the particles of the formulation exhibit a size of less than or equal to 4 μm.

13. A suspension concentrate as claimed in claim 12, wherein the active substance (component 1) is oxadiargyl.

14. A suspension concentrate as claimed in claim 12, wherein the active substance (component 1) is oxadiazon.

15. A process for the preparation of a suspension concentrate as claimed in claim 1, which comprises the wet milling of the components.

16. A composition which can be obtained from a suspension concentrate as claimed in claim 1 by diluting with liquids.

17. A process for combating undesirable plant growth, which comprises the application of a suspension concentrate as claimed in claim 1, optionally after dilution with water to the harmful plants, plant parts, plant seeds or the area on which the plants are growing.
